(19) United States
(12) Patent Application Publication
(10) Pub. No.: US 2009/0079207 A1
(43) Pub. Date: Mar. 26, 2009

(54) Attachable floating car trunk handle

(76) Inventors: Alex Manzhura, Vancouver, WA (US); Vitaliy Serebryanskiy, Vancouver, WA (US)

Correspondence Address: RYLANDER & ASSOCIATES PC, 406 West 12th Street, Vancouver, WA, 98660, US

(21) Appl. No.: 11/903,823

(22) Filed: Sep. 24, 2007

(51) Int. Cl. E05B 3/00

(52) U.S. Cl. 292/336.3

(57) ABSTRACT

An attachable floating handle apparatus that can be attached to a lifting vehicle door such as a car trunk boot lid, hatchback, or wing door, includes a handle pocket attachable to a car trunk or car hatchback door, a floating handle pivotally connected to said handle pocket, said floating handle including a gripping portion and a closed portion. The floating handle pivots in conjunction with the closing and opening of a car trunk or car hatchback door such that the floating handle gripping portion is not accessible when the trunk or hatchback door is closed, but is accessible when the trunk or hatchback door is open. The handle can attach to a car trunk, hatchback door, or wing door using contact adhesive. The floating handle can be provided with a protrusion opposite the gripping portion. The floating handle can be provided with a counterweight opposite the gripping portion. The handle pocket can be provided with a stop to act in conjunction with and opposite to a protrusion provided on the floating handle. The floating handle can be rotationally attached in and to said pocket whereby the floating handle is gravity actuated to rotate in said pocket.

### FIELD OF THE INVENTION

The present invention relates to attachable handles for lifting vehicle doors.

### BACKGROUND

Almost all automobiles are provided with lifting access doors of some kind, either a trunk boot lid, a lifting tailgate, a hatchback door, or side lifting passenger doors. These handle areas are designed to be part of the overall aesthetic appeal of the vehicle, so keeping this area clean is important to owners concerned about the condition and presentation of their vehicle, especially luxury cars. Generally an operator is required to grab the handle or the door itself resulting in smudges, road grime, or dirt diminishing the exterior appearance of the vehicle door. High polish finishes on modern vehicles, whether chrome or paint, make these unsightly marks stand out.

A number of devices have described handles for car doors or hatchbacks which make grabbing them easier, but none address the problem of providing a gripping surface for the operator which is not visible when closed so as to not show smudges and/or marks from handling.

Thus, there is a need for a handle that can be attached to a car trunk or hatch back that has a closed position when the trunk or hatchback is closed to shield the unsightly gripping portion from view, but which exposes the clean gripping portion when the lifting car door is raised.

Presently known art has not completely solved the problem. The following represents a list of known related art:

| Reference: | Issued to: | Date of Issue: |
|---|---|---|
| 6,385,816 | Baldas et al. | May 14, 2002 |
| 6,338,352 | Raches et al. | Jan. 15, 2002 |
| 5,314,668 | Biermaier | May 24, 1994 |
| 3,159,867 | Aciego | Dec. 8, 1964 |

The teachings of each of the above-listed citations (which does not itself incorporate essential material by reference) are herein incorporated by reference. None of the above inventions and patents, taken either singularly or in combination, is seen to describe the instant invention as claimed.

U.S. Pat. No. 6,385,816 to Baldas et al. disclosed a lift gate internal handle assembly which has a stowed position and extended position that pivots based on gravity. Baldas does not disclosed a handle attachable to a trunk or hatchback door, but instead a handle integral with the trunk or hatchback door. Baldas does not discuss or disclose a device to provide a surface for gripping which hides smudges caused by gripping from view when in a closed position. Moreover, Baldas teaches a handle which extends downward for gripping and pulling down, not a gripping portion which rotates upward.

U.S. Pat. No. 6,338,352 to Raches et al discloses a self rising door handle for a dishwasher door that pivots between an upstanding position and a flush position. Raches does not disclose a handle attachable to a trunk or hatchback door. Raches does not discuss or disclose a device to provide a surface for gripping which hides smudges caused by gripping from view when in a closed position.

The art described above does not teach or suggest an attachable floating trunk handle which has the following combination of desirable features: (1) can be sold as an aftermarket accessory; (2) can be easily installed without special training; (3) can be installed on a car trunk boot lid, hatchback door, or wing door; (4) provides a surface for gripping without leaving visible smudges when the trunk, hatchback door or wing door is closed; (5) reveals a hidden gripping surface when the car trunk, hatchback, or wing door is opened; and, (6) which provides an unmarred display area for a logo when the trunk, hatchback or wing door is closed.

### SUMMARY AND ADVANTAGES

An attachable floating handle apparatus that can be attached to a lifting vehicle door such as a car trunk boot lid, hatchback, or wing door, includes a handle pocket attachable to a car trunk or car hatchback door, a floating handle pivotally connected to said handle pocket, said floating handle including a gripping portion and a closed portion. The floating handle pivots in conjunction with the closing and opening of a car trunk or car hatchback door such that the floating handle gripping portion is not accessible when the trunk or hatchback door is closed, but is accessible when the trunk or hatchback door is open. The handle can attach to a car trunk, hatchback door, or wing door using contact adhesive. The floating handle can be provided with a protrusion opposite the gripping portion. The floating handle can be provided with a counterweight opposite the gripping portion. The handle pocket can be provided with a stop to act in conjunction with and opposite to a protrusion provided on the floating handle. The floating handle can be rotationally attached in and to said pocket whereby the floating handle is gravity actuated to rotate in said pocket.

The attachable floating handle apparatus of the present invention presents numerous advantages, including: (1) can be sold as an aftermarket accessory; (2) can be easily installed without special training; (3) can be installed on a car trunk boot lid, hatchback door, or wing door; (4) provides a surface for gripping without leaving visible smudges when the trunk, hatchback door or wing door is closed; (5) reveals a hidden gripping surface when the car trunk, hatchback, or wing door is opened; and, (6) which provides an unmarred display area for a logo when the trunk, hatchback or wing door is closed; and, (7) can be manufactured from a variety of materials.

Additional advantages of the invention will be set forth in part in the description which follows, and in part will be obvious from the description, or may be learned by practice of the invention. The advantages of the invention may be realized and attained by means of the instrumentalities and combinations particularly pointed out in the appended claims. Further benefits and advantages of the embodiments of the invention will become apparent from consideration of the following detailed description given with reference to the accompanying drawings, which specify and show preferred embodiments of the present invention.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention.

FIG. 1 shows a first embodiment of the disclosed invention showing generally a top down perspective view, with the gripping handle closed.

FIG. 2 shows another view of a first embodiment of the disclosed invention, with the gripping handle rotated to the open position.

FIG. 3 shows a side cutaway view of a first embodiment of the disclosed invention in the closed position.

FIG. 4 shows a side cutaway view of a first embodiment of the disclosed invention in the open position.

FIG. 5A shows a second embodiment of the disclosed invention with the gripping handle closed.

FIG. 5B shows a second embodiment of the disclosed invention with the gripping handle open.

FIG. 6A shows a side cut-away view of a second embodiment of the disclosed invention with the gripping handle in the closed position.

FIG. 6B shows a side cut-away view of a second embodiment of the disclosed invention with the gripping handle rotated to the open position.

FIG. 7 shows a perspective view of a second embodiment of the disclosed invention.

FIG. 7A shows a perspective view of a handle grip for a second embodiment of the disclosed invention.

FIG. 8A shows a side cutaway view of a third embodiment of the disclosed invention in the closed position.

FIG. 8B shows a side cutaway view of a third embodiment of the disclosed invention with the gripping handle rotated to the open position.

FIG. 9A shows a side cutaway view of a fourth embodiment of the disclosed invention in the closed position.

FIG. 9B shows a side cutaway view of a fourth embodiment of the disclosed invention with the gripping handle rotated to the open position.

FIG. 10A shows a side cutaway view of a fifth embodiment of the disclosed invention in the closed position.

FIG. 10B shows a side cutaway view of a fifth embodiment of the disclosed invention with the gripping handle rotated to the open position.

FIG. 10C shows a perspective view of a gripping handle of a fifth embodiment of the disclosed invention.

FIG. 11 shows a side cutaway view of a sixth embodiment of the disclosed invention with sliding cover.

FIG. 11A shows a detailed cutaway view of a sixth embodiment of the disclosed invention.

FIG. 11B shows a side cutaway view of a seventh embodiment of the disclosed invention including a solenoid actuator and simple circuit.

FIG. 12A shows a side cutaway view of a eighth embodiment of the disclosed invention with a recessed handle body and legs rotating connected to the handle body.

FIG. 12B shows a side cutaway view of an eighth embodiment of the disclosed invention with a recessed handle body and legs rotating connected to the handle body and including a solenoid actuator.

FIG. 13A shows a side cutaway view of a ninth embodiment of the disclosed invention.

FIG. 13B shows a side cutaway view of a ninth embodiment of the disclosed invention with the gripping handle rotated to open.

### DETAILED DESCRIPTION

Before beginning a detailed description of the subject invention, mention of the following is in order. When appropriate, like reference materials and characters are used to designate identical, corresponding, or similar components in differing figure drawings. The figure drawings associated with this disclosure typically are not drawn with dimensional accuracy to scale, i.e., such drawings have been drafted with a focus on clarity of viewing and understanding rather than dimensional accuracy.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

An attachable floating handle apparatus that can be attached to a lifting vehicle door such as a car trunk boot lid, hatchback, or wing door, includes a handle pocket attachable to a car trunk or car hatchback door, a floating handle pivotally connected to said handle pocket, said floating handle including a gripping portion and a closed portion. The floating handle pivots in conjunction with the closing and opening of a car trunk or car hatchback door such that the floating handle gripping portion is not accessible when the trunk or hatchback door is closed, but is accessible when the trunk or hatchback door is open. The handle can attach to a car trunk, hatchback door, or wing door using contact adhesive. The floating handle can be provided with a protrusion opposite the gripping portion. The floating handle can be provided with a counterweight opposite the gripping portion. The handle pocket can be provided with a stop to act in conjunction with and opposite to a protrusion provided on the floating handle. The floating handle can be rotationally attached in and to said pocket whereby the floating handle is gravity actuated to rotate in said pocket.

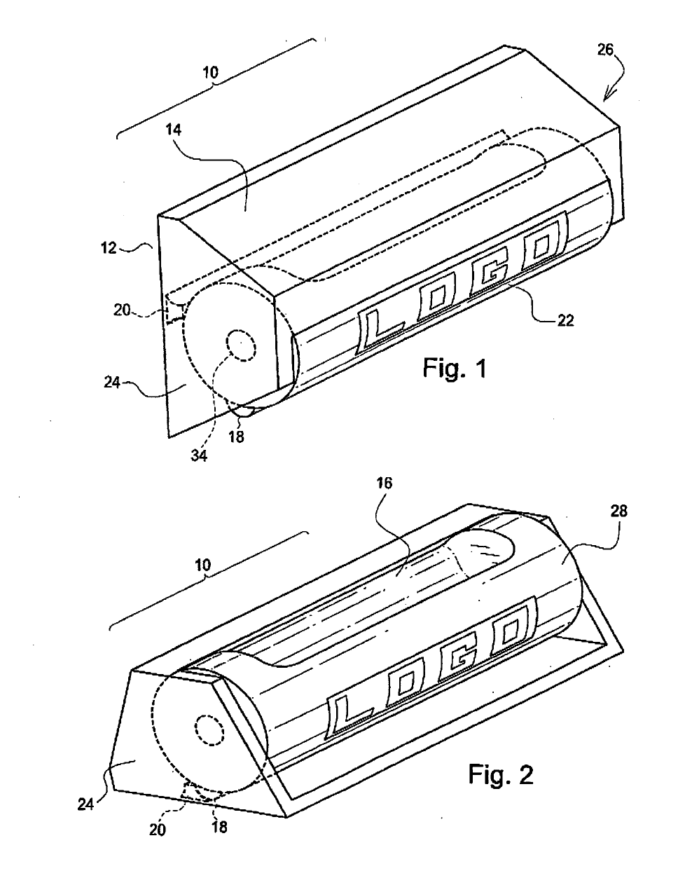

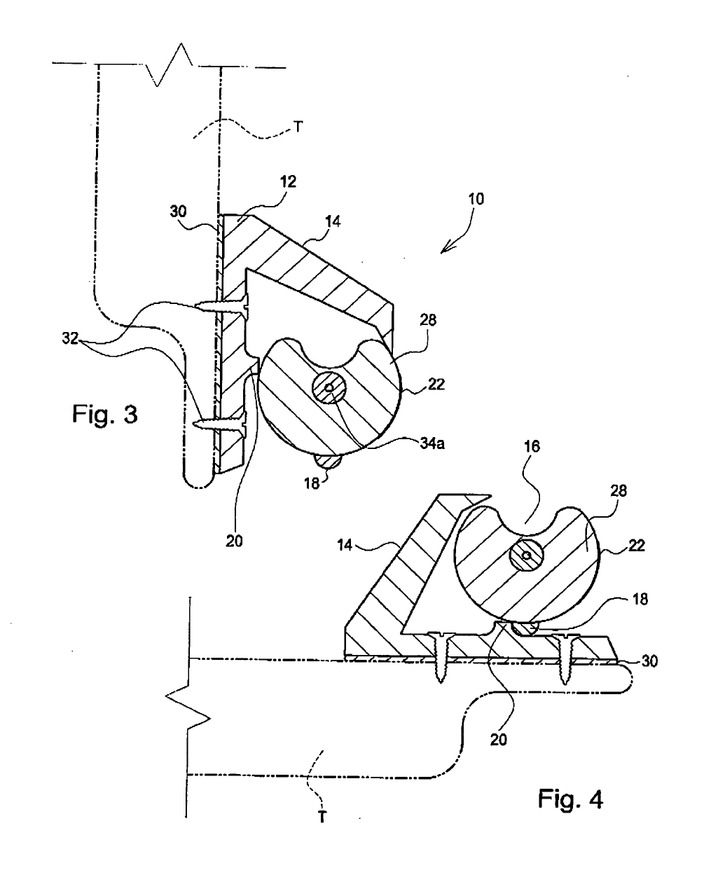

As shown in FIGS. 1-4, a floating door handle 10 attachable to a lifting vehicle door includes a handle pocket 12 with a top shield 14, first and second sidewalls 24 and 26, and floating handle stop 20; a handle grip 28 at least partially contained within handle pocket 12 and rotatingly connected to handle pocket 12 at first and second sidewalls 24 and 26 using rotating connector 34. Handle grip 28 includes gripping channel 16 and ridge 18 opposite gripping channel 16, and handle grip 28 is asymmetrically weighted toward ridge 18. In this way handle grip 28 rotates automatically by force of gravity in conjunction with the opening and closing of lifting vehicle door T such that gripping channel 16 is hidden under top shield 14 when lifting car door T is closed (see FIGS. 1 & 3), and handle grip 28 rotates until ridge 18 contacts floating handle stop 20 to hold handle grip 28 in an accessible position when lifting vehicle door T is at least partially raised (see FIGS. 2 & 4). Ridge 18 also provides leverage against stop 20 when closing. A floating handle 10 may be attached to a lifting vehicle door using contact adhesive 30, threaded fasteners 32, or a combination of each. Alternatively, a floating door handle 10 may be installed in a cutout within a lifting vehicle door as a factory installed feature for new-production automobiles, or attached to a door using methods known to those of skill in the art.

As shown in FIGS. 1-4, an attachable floating handle 10 is provided that can be attached to a lifting vehicle door T or other vehicle door that raises. In this specification the term “lifting vehicle door” includes lifting trunks or boot lids, hatchback doors and lifting wing doors within its definition. As shown in FIGS. 1 & 3, floating door handle 10 is closed when the lifting vehicle door T is in the closed position, but rotates to the open position when lifting vehicle door T is raised, see FIGS. 2 & 4, such that when an operator grabs the handle to close the trunk their fingers contact the now exposed grip channel 16 to close the trunk, and the handle “floats” or rotates back to the closed position, thereby hiding unsightly smudge marks from view. Handle grip connector 34 provides a rotating connection between handle grip 28 and sidewalls 24 and 26. Rotating connector 34 may consist of a simple axle and socket combination, or alternatively they may incorporate friction reducing bearings, such as ball bearings contained in races, to provide smoother operation. Rotating connector 34 may incorporate a through axle or side axles.

Handle pocket 12 and handle grip 28 are preferably made with chrome plated steel or paint matching that of the door T to which it is attached. Alternative materials or finishes may be used for aesthetic purposes. Where handle pocket 12 contacts the surface of a vehicle door the material should be selected for compatibility to prevent corrosion or direct metal-to-metal contact should be avoided, for instance by utilizing an adhesive layer 30 or by inserting a thin sheet of plastic or fiberglass between handle pocket 12 and lifting door T. Alternatively, handle pocket 12 itself could be made from a non-metallic material such as fiberglass or molded plastic, used in many car body parts. Handle grip 28 is provided with a display area 22. Display area 22 is exposed when the door is down, and may be decorated with aesthetic designs or a logo, such as a trademark or a person's name. Alternatively, display area 22 may be devoid of logo and left as a clean polished surface for aesthetic purposes. Handle pocket 12 may be attached using adhesive 30 or threaded fasteners 32, or a combination of these. In an embodiment adhesive 30 is a contact adhesive or adhesive pad.

As shown in FIGS. 1 & 3, when the lifting door T is closed the attachable floating trunk handle 10 is in the closed position and grip channel 16 is concealed from view and display area 22 is exposed. As shown in FIGS. 2 & 4, when the lifting door T is lifted handle grip 28 automatically rotates about rotating connection 34 due to gravity acting on asymmetrically weighted handle grip 28 to expose gripping channel 16 for the operator. As shown in FIG. 1, when door T is closed handle grip 28 rotates back to its stowed position, hiding gripping channel 16 and leaving display area 22 exposed.

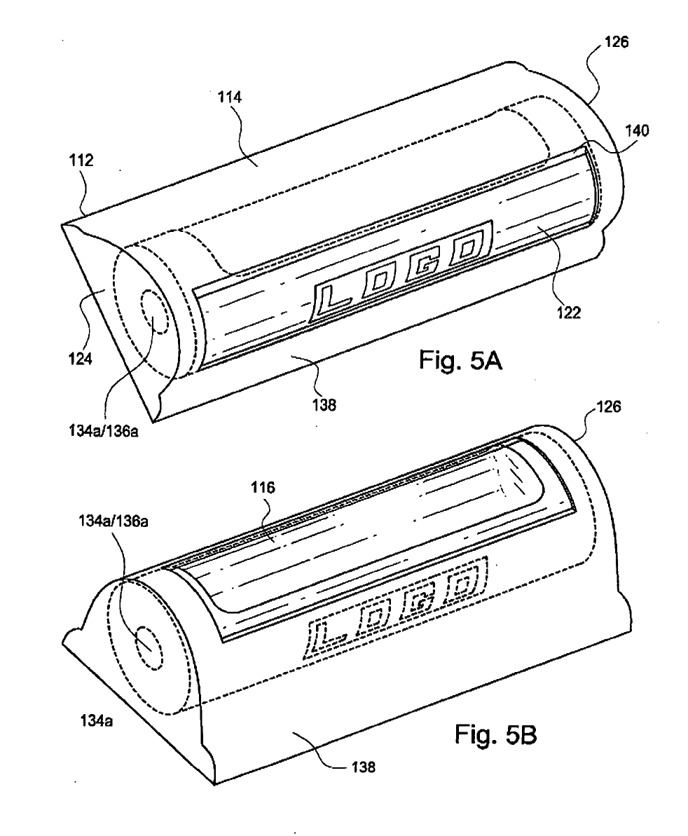

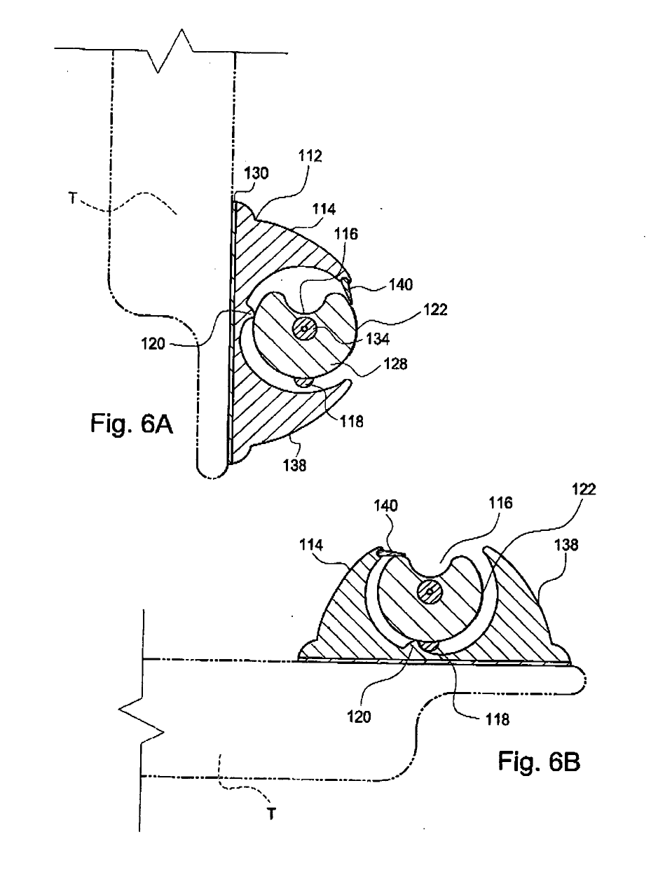

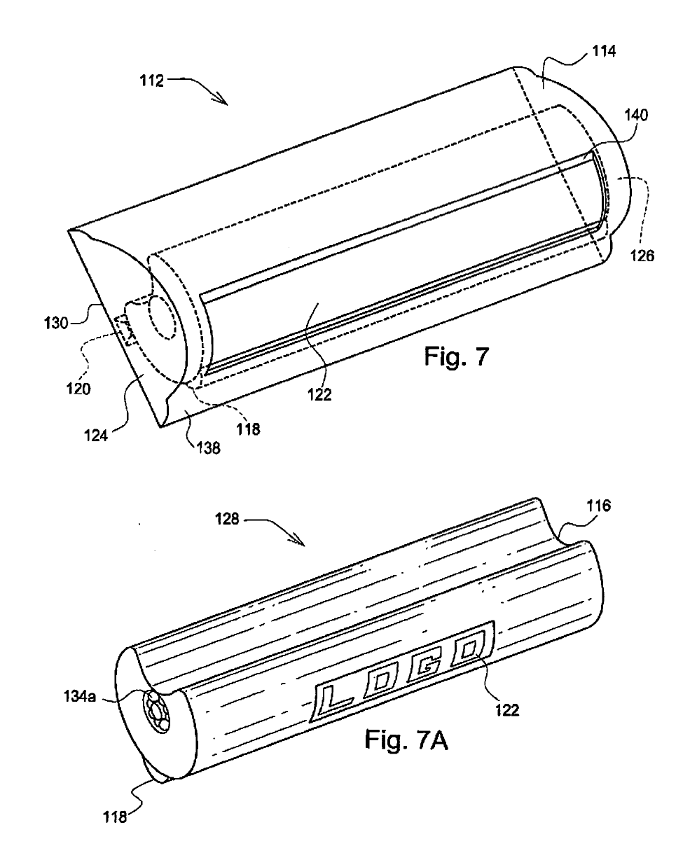

In a second embodiment, shown in FIGS. 5A-7A, handle grip 128 is partially contained within handle pocket 112. Handle pocket 112 includes top shield 114, and a bottom shield 138. Handle grip 128 includes grip channel 116, ridge 118, and display area 122. Handle pocket 112 incorporates floating handle stop 120 to engage ridge 118 when lifting door T is at least partially open. Handle grip 128 is asymmetrically weighted away from grip channel 116 so that grip channel 116 is covered by top shield 114 when lifting door T is closed, but rotates automatically about rotating connector 134 by force of gravity to expose grip channel 116 when lifting door T is at least partially raised. Top wiper 140 extends from top shield 114, and is in continuous contact with handle grip 128, and gripping channel 116 is shielded by top wiper 140 when lifting door T is in the closed position.

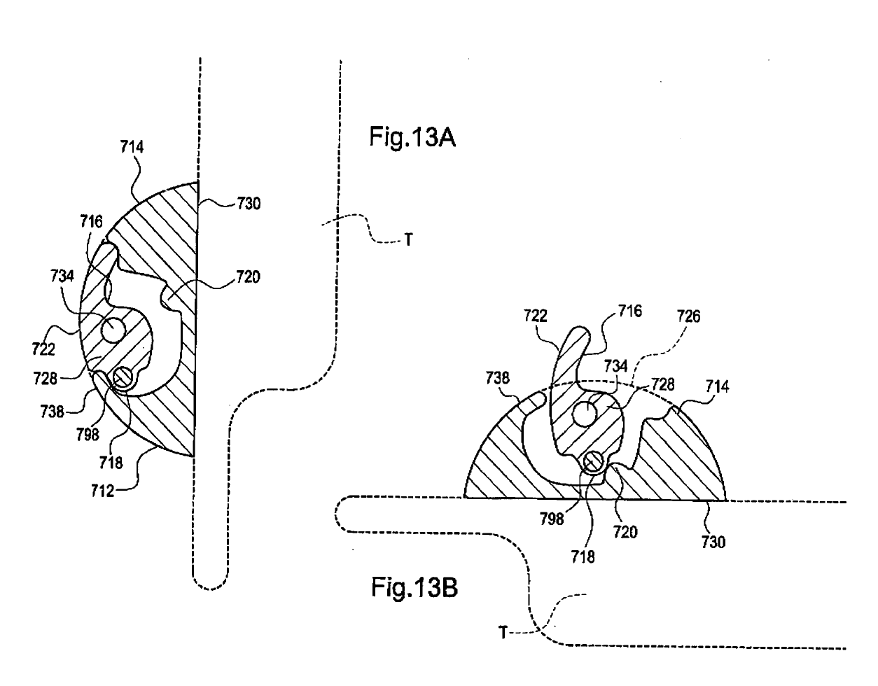

As shown in FIGS. 13A & B, a third embodiment includes an offset grip channel 716. When lifting door T is raised handle grip 728 rotates about rotating connector 734, rotatingly connected to sidewalls 724 (not shown) and 726 (shown in outline) due assymetric weighting created through counter weight 798, until ridge 718 rests against floating handle stop 720. Display area 722 is presented when handle grip 728 is in the closed position. As shown in FIG. 13A, ridge 718 rests against bottom shield 738 when lifting door T is in the closed position. Handle pocket 712 is attached to lifting vehicle door T using adhesive 730.

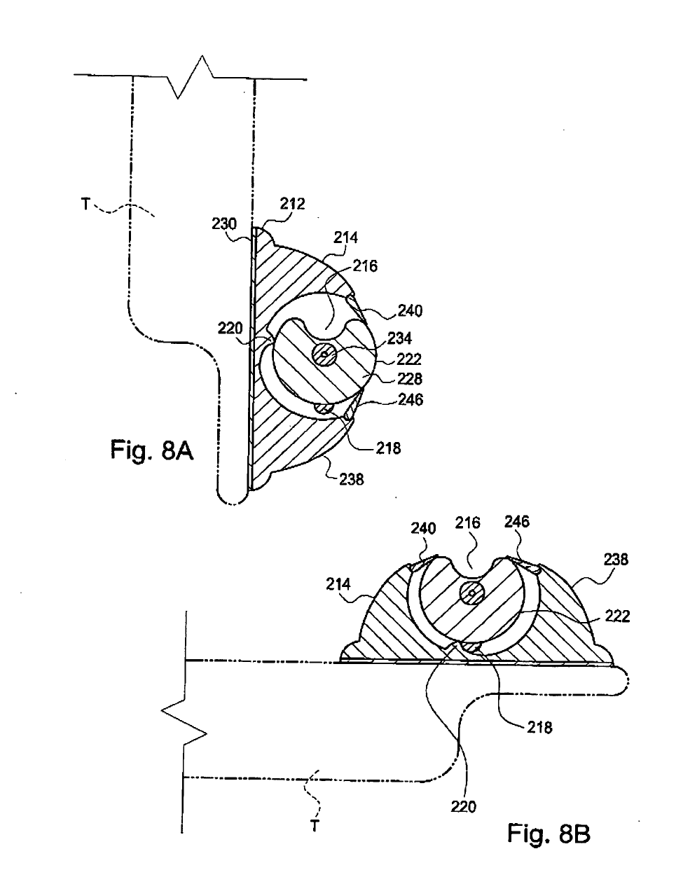

In a fourth embodiment, as shown in FIGS. 8A & B, a floating door handle includes handle pocket 212 with bottom shield 238, and bottom wiper 246 extending from bottom shield 238, wherein bottom wiper 246 is in continuous contact with handle grip 228. Top wiper 240 extends from top shield 214 and also is in continuous contact with handle grip 228. Gripping channel 216 is more protected from dirt and weather by top wiper 240 when lifting door T is in the closed position (see FIG. 8A). In this embodiment, bottom wiper 246 extends from bottom shield 238 to provide additional protection from dirt and water entry. Additionally, the rubbing of bottom wiper 238 against display area 222 will assist in maintaining display area 222 clean. When lifting vehicle door T is raised (see FIG. 8B) handle grip 228 rotates about rotating connector 234 until ridge 218 contacts floating handle stop 220, thereby exposing gripping channel 216. Handle pocket 212 is attached to vehicle lifting door T by adhesive 230.

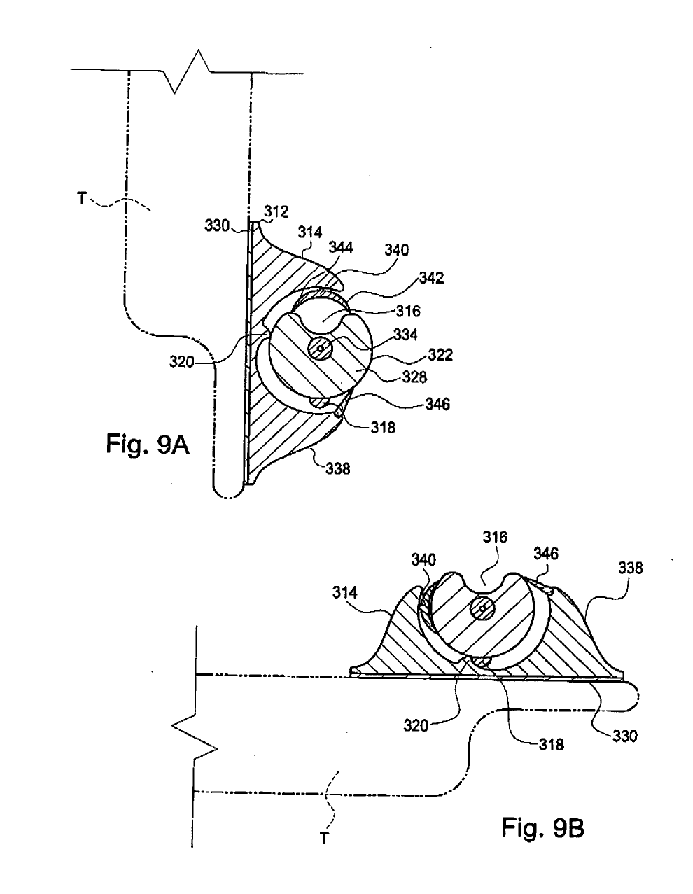

In a fifth embodiment, as shown in FIGS. 9A & B, a floating door handle 310 includes a top wiper 340 extending from top shield 314, wherein top wiper 340 further includes first and second wiper blades 342 and 344 which span and seal gripping channel 316 when lifting vehicle door T is in the closed position (see FIG. 9A). Handle pocket 312 includes top shield 314 and bottom shield 338. Gripping handle 328 is connected to handle pocket 312 by rotating connector 334. When lifting door T is opened grip handle 328 rotates until ridge 318 contacts stopper 320 to hold grip handle 328 in the open position. Top and bottom wipers 340 and 346 are in continuous contact with handle grip 328. Display area 322 is visible when lifting vehicle door T is closed (FIG. 9A).

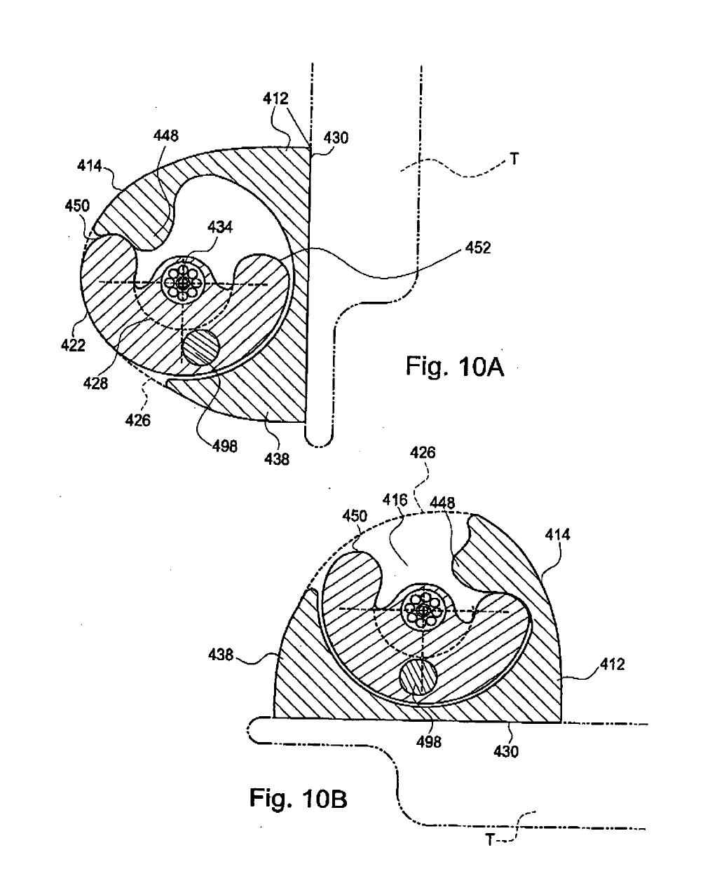

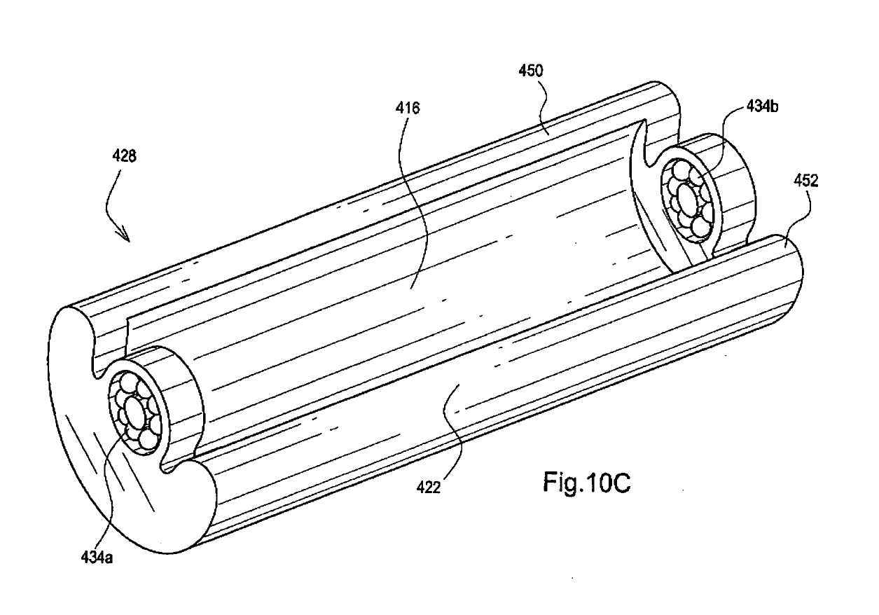

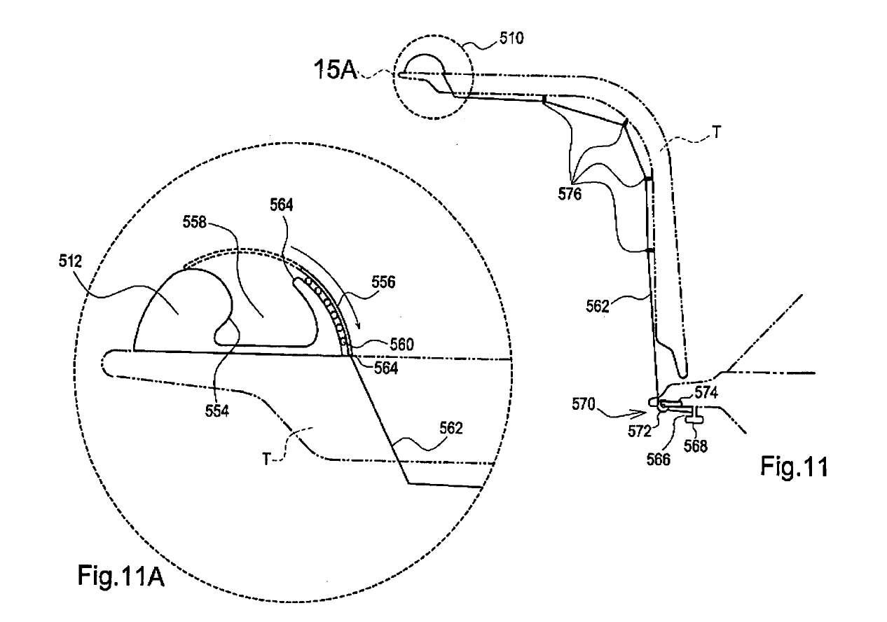

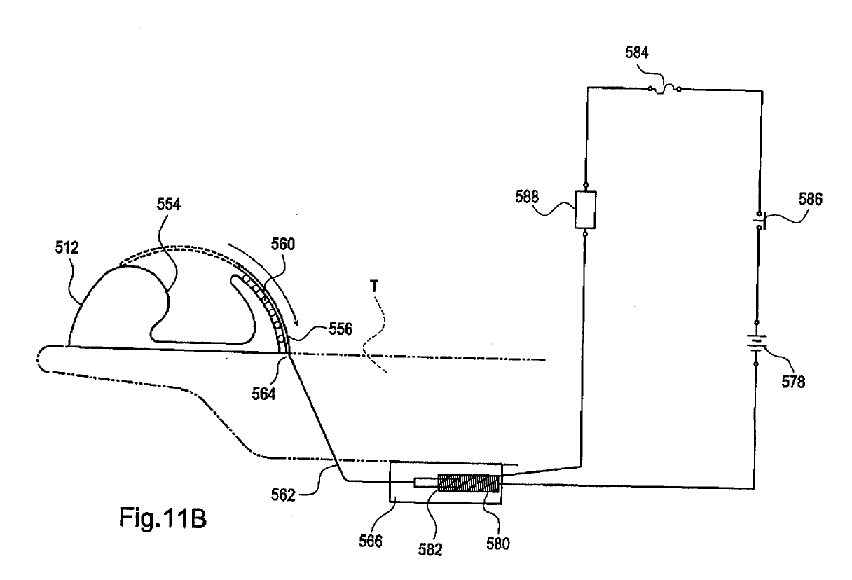

In a sixth embodiment, as shown in FIGS. 10A-C, a floating door handle includes a handle pocket 412 with attachment means 430 for attaching to a lifting vehicle door T, a top shield 414 including a stop 448 extending therefrom, and first and second sidewalls 424 and 426 (426 shown in background profile, 424 not shown). Handle grip 428 is disposed at least partially within handle pocket 412 and rotatingly connected to handle pocket 412 by rotating connectors 434 to handle pocket first and second sidewalls 424 and 426. Handle grip 428 includes a grip channel 416 extending lengthwise along handle grip 428 forming first and second handle grip channel lips 450 and 452 along opposing sides of gripping channel 416. Handle grip 428 is asymmetrically weighted away from gripping channel 416 such that gravity naturally forces gripping channel lip 450 closed against stop 448 when lifting vehicle door T is closed and display area 422 is exposed to view. Counterweight 498 may be added to increase the weighting if handle grip 428 is made from a material that is lightweight, in order to ensure adequate holding. Alternatively, counterweight 498 may be made from a ferrous or similar material which may be engaged by a small electro-magnet coil embedded within bottom shield 438. The electro-magnet may be activated upon closure of lifting door T and deactivated when lifting door T is unlatched to open, for instance by using simple interlocks already in place for the interior lights of a car interior or trunk. When lifting vehicle door is opened handle grip 428 rotates until gripping channel lip 452 rests against stop 448, thereby exposing gripping channel 416 to the operator. As shown in FIG. 10C, rotating connector 434 includes ball bearings 434a & b in races to reduce friction.

In a seventh embodiment, shown in FIGS. 11 & 11A, a floating handle 510 for a lifting vehicle door T includes a floating handle body 512 attachable to a lifting vehicle door T which contains a handle cavity 558 within, handle grip 554 contained within handle cavity 558, a floating cover 556 connected to handle body 512 which encloses handle cavity 558 and which is movable between a closed position hiding handle grip 554 from view and an open position exposing handle grip 554, and operating means for moving floating cover 556 from its closed position to its open position. In an embodiment, floating cover 556 moves along a ball bearing channel 560. Operating means for a floating cover 556 includes cable 562 with a first end 564 attached to floating cover 556 and a second end 566 attached to a fixed anchor 568. Cable 562 passes over cable support bearing 570. Cable support bearing 570 includes a channeled rotating wheel 572 connected to a fixed base 574. Cable support bearing 570 is displaced off-axis from the hinge point of lifting door T, so that when lifting door T lifts cable 562 is pulled taught around cable support 570 thereby causing floating cover 556 to be pulled open to expose handle grip 554. Cable 562 is maintained in position by retaining hooks 576. When lifting vehicle door T closes cover 556 returns to its closed position by force of gravity.

In an eighth embodiment, shown in FIG. 11B, operating means for a floating cover 556 includes an electrical solenoid 580, means for selectively energizing or de-energizing solenoid 580 such as push button 586, a solenoid plunger 582 movable by electrical solenoid 580, and connecting means, in this embodiment cable 562 with a first end 564 connected floating cover 556 and a second end 566 connected to solenoid plunger 582, for mechanically connecting solenoid plunger 582 to floating handle cover 556 to selectively open or close cover 556. Solenoid 580 may be energized or de-energized via push button 586 inside the passenger compartment of the vehicle (not shown) or other means. Solenoid actuators impart mechanical force by creating a magnetic field from current through a coil, which magnetic field acts on a ferrous or magnetically susceptible armature. The principles upon which electrical solenoids operate are well known, but the particular means by which solenoid actuators impart mechanical force when the solenoid coil is energized vary greatly. For instance, a very simple solenoid actuator could consist of an electrical coil with a ferrous cylinder which is drawn into the coil when current runs through the coil, and this movement of the ferrous cylinder provides the mechanical force of the solenoid actuator. Solenoid actuators may also use lever arms, rotating arms or other means to transmit mechanical force. In this specification, therefore, “solenoid plunger” refers generally to the mechanical portion of a solenoid actuator, i.e. the portion that moves so as to transmit mechanical force to some other object, and is not limited to a cylinder drawn into a solenoid coil.

Means 586 for energizing solenoid 580 may include a timing circuit 588 which will automatically energize solenoid 580 to open floating handle cover 556 when lifting door T is released from its latch (not shown), and which will automatically de-energize solenoid 580 after lifting door T is closed or after a pre-determined time, thereby causing floating handle cover 556 to return to its closed position. Timing circuit 588 prevents floating handle cover 556 from closing on an operator's fingers when shutting door T, and also prevents overheating solenoid 580 when lifting door T is held open for prolonged periods. A fusible link 584 is included for secondary overcurrent protection. Timing circuit 588 may incorporate existing timing circuits which operate car interior and trunk lights to save time and minimize complexity, or may be a separate circuit dedicated to the floating handle.

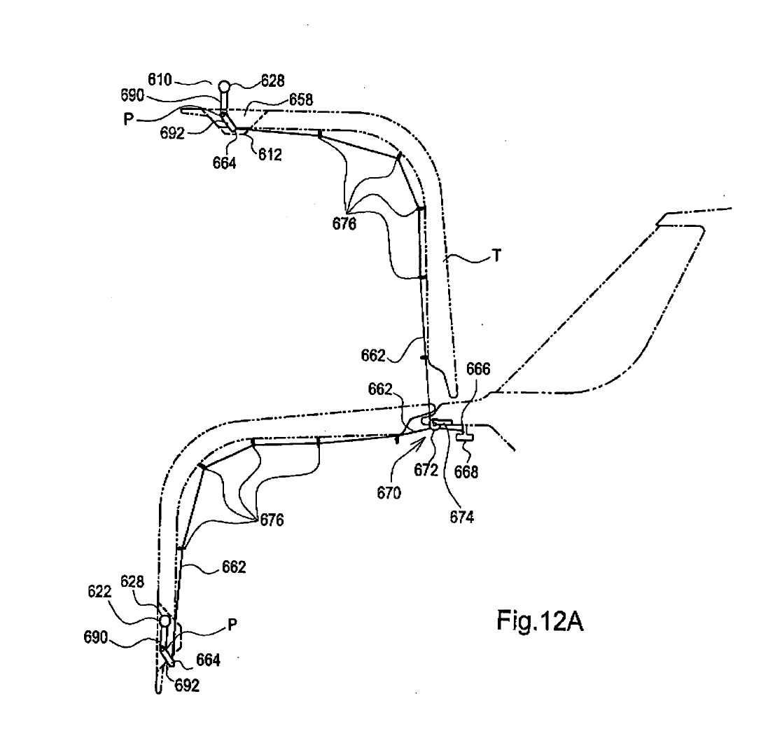

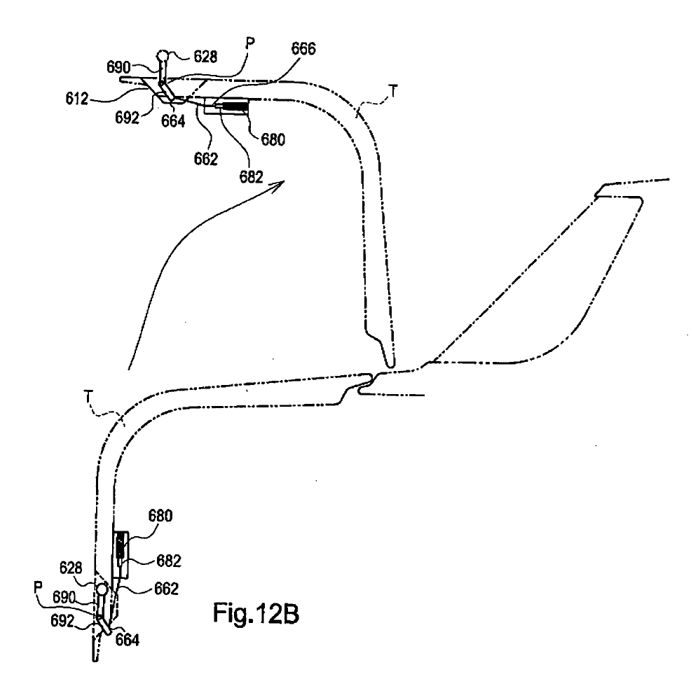

In a ninth embodiment, as shown in FIG. 12A, a floating handle 610 for a lifting vehicle door T is shown which includes handle body 612 attachable to a lifting vehicle door T. Handle body 612 has a recess 658 for containing handle grip 628, which includes one or more legs 690 rotatingly connected to handle body 612 at pivot point P, with handle grip 628 movable between a recessed position within handle body 612 and an extended position. Operating means for moving handle grip 628 from a recessed position to an extended position includes fixed anchor 668, a lever arm 692 with a first and second ends where lever arm first end is connected to at least one of handle grip 628's one or more legs at pivot point P; and, a cable 662 with first end 664 and second end 666. Cable first end 664 is connected to lever arm 692 second end to create the lever action, and cable second end 666 is connected to fixed anchor 668. Cable support bearing 672 is in contact with cable 662 at a point that is displaced off-axis from the hinge of lifting vehicle door T such that when lifting vehicle door T is raised cable 662 is drawn taught about cable support bearing 672, thereby acting on lever arm 692 to move it about pivot point P and move handle grip legs 690, so that handle grip 628 moves from a recessed position to an extended position. When lifting vehicle door T is closed handle grip 628 returns to a recessed position by force of gravity. Cable support bearing 670 includes a channeled rotating wheel 672 connected to a fixed base 674.

In a tenth embodiment, as shown in FIG. 16B, floating handle 610 operating means includes an electrical solenoid 680, means for selectively energizing or de-energizing solenoid 680 such as described in FIG. 11B, a solenoid plunger 682 movable by electrical solenoid 680, and connecting means for mechanically connecting solenoid plunger 682 to handle grip 628 to move handle grip 628 between the recessed and extended positions. Means for energizing can include a timing circuit, wherein solenoid 680 is automatically energized to extend handle grip 628 when lifting vehicle door T is unlatched, and solenoid 680 is automatically de-energized by the timing circuit after the lifting vehicle door T is closed, which allows handle grip 628 to return to the recessed position by force of gravity. In this embodiment, connecting means for connecting solenoid plunger 682 to handle grip 628 include a lever arm 692 with first and second ends, where lever arm 692 first end is connected to at least one of handle grip legs 690 at pivot point P and a cable 662 with a first end 664 connected to the second end of lever arm 690 and a second end 666 connected to solenoid plunger 682.

Those skilled in the art will recognize that numerous modifications and changes may be made to the preferred embodiment without departing from the scope of the claimed invention. It will, of course, be understood that modifications of the invention, in its various aspects, will be apparent to those skilled in the art, some being apparent only after study, others being matters of routine mechanical, chemical and electronic design. No single feature, function or property of the preferred embodiment is essential. Other embodiments are possible, their specific designs depending upon the particular application. As such, the scope of the invention should not be limited by the particular embodiments herein described but should be defined only by the appended claims and equivalents thereof.

I claim:

1. An attachable floating handle for a lifting vehicle door, comprising:
a handle pocket attachable to a lifting vehicle door, said handle pocket including a top shield, first and second sidewalls, and a floating handle stop;
a handle grip at least partially contained within said handle pocket and rotatingly connected to said handle pocket at said first and second sidewalls, said handle grip including a gripping channel and a ridge opposite said gripping channel, and wherein said handle grip is asymmetrically weighted toward said ridge;
wherein said handle grip rotates automatically by force of gravity in conjunction with the opening and closing of said lifting vehicle door such that said gripping channel is hidden under said top shield when said lifting car door is closed, and wherein said handle grip rotates until said ridge contacts said floating handle stop to hold said handle grip in an accessible position when said lifting vehicle door is raised.

2. The apparatus of claim 1, wherein said handle pocket is attached to a lifting vehicle door using adhesive.

3. The apparatus of claim 1, wherein said handle pocket is attached to a lifting vehicle door using threaded fasteners.

4. The apparatus of claim 1, wherein said handle grip further includes a display portion incorporating a logo which is exposed when said lifting car door is closed.

5. An attachable floating handle as in claim 1, further comprising:
a top wiper extending from said top shield, wherein said top wiper is in continuous contact with said handle grip, and said gripping channel is shielded by said top wiper when said lifting car door is in the closed position.

6. An attachable floating handle as in claim 7, wherein said to top wiper includes a first wiper blade and a second wiper blade, said first and second wiper blades spanning and sealing said gripping channel when said floating handle is in the closed position.

7. An attachable floating handle as in claims 5 or 6, further comprising:
a bottom shield extending from said handle pocket; and,
a bottom wiper extending from said bottom shield, wherein said bottom wiper is in continuous contact with said floating handle.

8. An attachable floating handle for a lifting vehicle door comprising:
a handle pocket, said handle pocket comprising attachment means for attaching to a lifting vehicle door, a top shield including a stop extending from said top shield, and first and second sidewalls; and,
a handle grip disposed at least partially within said handle pocket and rotatingly connected to said handle pocket at said first and second sidewalls, said handle grip including a display area, a gripping channel extending lengthwise along said handle grip, and first and second lips along opposing sides of said gripping channel, and wherein said handle grip is asymmetrically weighted away from said gripping channel;
wherein, when said lifting vehicle door is closed, said first lip rests against said top shield stop such that said handle grip display area is exposed to view, and when said lifting vehicle door is raised said handle grip rotates until said inner lip rests against said top shield stop, thereby exposing said gripping channel to an operator.

9. A floating handle for a lifting vehicle door, comprising:
a handle body attachable to a lifting vehicle door;
a handle grip contained within said floating handle body;
a cover connected to said handle body and movable between a closed position hiding said handle grip from view and an open position exposing said handle grip;
operating means for moving said cover from said closed position to said open position, and from said open position to said closed position.

10. A floating handle as in claim 9, wherein said operating means comprises an electrical solenoid, means for selectively energizing or de-energizing said solenoid, a solenoid plunger movable by said electrical solenoid, and connecting means for mechanically connecting said plunger to said cover to selectively open or close said cover.

11. A floating handle as in claim 10 where said means for energizing further includes a timing circuit, wherein said solenoid is automatically energized to open said cover when said lifting door is unlatched, and said solenoid is automatically de-energized by said timing circuit after said lifting door is closed, thereby allowing said cover to return to its closed position.

12. A floating handle as in claim 10 wherein said connecting means comprises a cable with first and second ends, wherein said first end is attached to said cover and said second end is attached to said solenoid plunger.

13. A floating handle as in claim 9 wherein said operating means comprises a fixed anchor, a cable support bearing, and a cable with a first end attached to said cover and a second end attached to said fixed anchor, wherein said cable is in contact with said cable support bearing.

14. A floating handle for a lifting vehicle door, comprising:
a handle body attachable to a lifting vehicle door, said handle body including a recess for containing a handle grip;
a handle grip including one or more legs rotatingly connected to said handle body at a pivot point, said handle grip movable between a recessed position within said handle body and an extended position; and,
operating means for moving said handle grip from said recessed position to said extended position;
wherein, said handle grip returns to said recessed position by gravity.

15. A floating handle as in claim 14, wherein said operating means comprises an electrical solenoid, means for selectively energizing or de-energizing said solenoid, a solenoid plunger movable by said electrical solenoid, and connecting means for mechanically connecting said plunger to said handle grip to move said handle grip between the recessed and extended positions.

16. A floating handle as in claim 15 where said means for energizing further includes a timing circuit, wherein said solenoid is automatically energized to extend said handle grip when said lifting door is released, and said solenoid is automatically de-energized by said timing circuit after said lifting door is closed thereby allowing said handle grip to return to the recessed position.

17. A floating handle as in claim 15 or 16 wherein said connecting means comprises:
a lever arm with first and second ends, said first lever arm end connected to at least one of said handle grip one or more legs at said pivot point; and,
a cable with first and second ends, said cable first end connected to said lever arm second end and said cable second end connected to said solenoid plunger.

18. A floating handle as in claim 14 wherein said operating means comprises:
a fixed anchor;
a lever arm with first and second ends, said first lever arm end connected to at least one of said handle grip one or more legs at said pivot point; and,
a cable with first and second ends, said cable first end connected to said lever arm second end and said cable second end connected to said fixed anchor;
a cable support bearing in contact with said cable.
